(19) United States
(12) Patent Application Publication
(10) Pub. No.: US 2024/0081352 A1
(43) Pub. Date: Mar. 14, 2024

(54) Blending Method of High-Quality and Dual-Purpose Flour for Bread and Noodles

(71) Applicant: Crop Research Institute, SAAS, Jinan (CN)

(72) Inventors: Yan Zi, Jinan (CN); Jianmin Song, Jinan (CN); Xiao Ma, Jinan (CN); Aifeng Liu, Jinan (CN); Wei Ju, Jinan (CN); Haosheng Li, Jinan (CN); Dungong Cheng, Jinan (CN); Canguo Wang, Jinan (CN); Jun Guo, Jinan (CN); Jianjun Liu, Jinan (CN); Xinyou Cao, Jinan (CN); Cheng Liu, Jinan (CN); Shengnan Zhai, Jinan (CN); Faji Li, Jinan (CN); Ran Han, Jinan (CN); Zhendong Zhao, Jinan (CN)

(21) Appl. No.: 17/942,173

(22) Filed: Sep. 11, 2022

(51) Int. Cl. A21D 10/00; A21D 13/02; A23L 7/10

(52) U.S. Cl. CPC A21D 10/005; A21D 13/02; A23L 7/198; A23V 2002/00

(57) ABSTRACT

The present disclosure provides a blending method of high-quality and dual-purpose flour for bread and noodles, belonging to the technical field of flour processing. The method includes: selecting flour of a high-quality and dual-purpose wheat variety for bread and noodles as a high-quality basic flour for blending; according to a large gradient experimental design, selecting a gradient range ratio with a sedimentation value ≥46.0 mL and a dough development time ≥9.6 min, followed by subdividing for small gradient experiments; selecting a ratio with flour sedimentation value and dough development time that reach an ideal value to blend a large amount of flour; and making bread and noodles for scoring, followed by determining a blending ratio if a scoring result reaches an ideal value.

### FIELD OF THE INVENTION

The present disclosure relates to the technical field of flour processing, in particular to a blending method of high-quality and dual-purpose flour for bread and noodles.

Although bread only accounting for 4% to 5% of wheat consumption, it plays an extremely important role in food industry. Even though some high-quality wheat varieties for bread have been bred in China, due to low yield and individual planting patterns of thousands of households, commercial production of these varieties is seriously affected, resulting in an extremely small planting area of wheat. High-quality wheat raw materials for bread mainly depend on imports. In addition, traditional foods such as noodles are the mainstay of wheat-based food consumption in China. Blending high-quality and dual-purpose flour for bread and noodles can meet the needs of the food industry to produce high-grade bread, as well as meet the wishes of farmers and food industry to produce various types of noodles.

Flour blending is to blend basic flour with different properties according to a certain proportion, thereby preparing special flour that meets specific food processing. The special flour refers to wheat flour produced according to processing needs of different pasta products. At present, demand for special flour in the market is increasing, and flour blending is increasingly important for food processing of enterprises. However, it is difficult to produce special flour from a single wheat variety. In flour production enterprises, basic flour of different qualities are generally matched in different proportions according to production needs, followed by adding food improvers or flour additives appropriately to change proteins, starch and dough properties of the flour, thereby producing various high-quality and wheat-based special flour that meets the needs of food processing.

So far, there is no report on establishing a simple and effective blending method of high-quality and dual-purpose flour for bread and noodles by only using index of eigenvalue of proteins and dough properties of flour in different wheat varieties without adding food improvers or flour additives.

### SUMMARY OF THE INVENTION

An objective of the present disclosure is to provide a blending method of high-quality and dual-purpose flour for bread and noodles. The method is simpler, more effective, greener and safer.

To achieve the above objective, the present disclosure provides a following technical solution.

The present disclosure provides a blending method of high-quality and dual-purpose flour for bread and noodles, including following steps:
(1) setting 2-3 of large gradient range ratios for high-quality basic flour and non-high-quality basic flour, and selecting a large gradient range ratio with a sedimentation value ≥46.0 mL and a dough development time ≥9.6 min;
(2) selecting the large gradient range ratio with a sedimentation value ≥46.0 mL and a dough development time ≥9.6 min for small gradient proportion, and selecting a small gradient range ratio with a sedimentation value ≥46.0 mL and a dough development time ≥9.6 min; and
(3) blending the high-quality basic flour and the non-high-quality basic flour according to the small gradient range ratio obtained in step (2), making bread and noodles for scoring, and determining a blending ratio when a score is greater than or equal to 80 points to terminate the blending.

Preferably, in step (3), if the score is less than 80 points, step (2) may be repeated until the score is greater than or equal to 80 points, followed by determining the blending ratio to terminate the blending.

Preferably, the non-high-quality basic flour is selected from a group consisting of inferior basic flour and common basic flour; and the inferior basic flour is derived from a group consisting of Lumai 1, Lumai 14, Qingfeng 1 and Tainong 18.

Preferably, the high-quality basic flour is wheat flour of a high-quality and dual-purpose for bread and noodles, and the wheat flour of a high-quality and dual-purpose for bread and noodles have a sedimentation value ≥46.0 mL and a dough development time ≥9.6 min.

Preferably, a high-quality and dual-purpose wheat for bread and noodles is selected from the group consisting of Zhengmai 366, Jimai 20 and Jimai 954072.

Preferably, in steps (1) and (2), the sedimentation value can be ≥48.0 mL, and the dough development time can be ≥10.5 min.

Preferably, in steps (1) and (2), the sedimentation value can be ≥53.6 mL, and the dough development time can be ≥11.9 min.

Preferably, when the high-quality basic flour is Zhengmai 366 and the non-high-quality basic flour is common basic flour, the Zhengmai 366 and the common basic flour can have a blending ratio of 7:3 to 8:2.

Preferably, the Zhengmai 366 and the common basic flour can have a blending ratio of 7:3.

The present disclosure has the following beneficial effects.

The present disclosure provides a blending method of high-quality and dual-purpose flour for bread and noodles. In the method, no food improver or flour additive is added, and the high-quality and dual-purpose flour for bread and noodles is blended only according to the index of eigenvalue of proteins and dough properties of flour in different wheat varieties. Compared with the prior art, the method is more efficient, simpler, lower cost, greener and safer.

### BRIEF DESCRIPTION OF THE DRAWINGS

FIG. 1 is a quality comparison chart of noodles prepared from different wheat varieties.

FIG. 2 is a quality comparison chart of breads prepared from different wheat varieties.

FIG. 3 is a quality comparison chart of two groups of noodles after flour blending.

FIG. 4 is a quality comparison chart of two groups of breads after flour blending.

### DETAILED DESCRIPTION OF ILLUSTRATED EMBODIMENT(S)

The present disclosure provides a blending method of high-quality and dual-purpose flour for bread and noodles, including the following steps:
(1) setting 2-3 of large gradient range ratios for high-quality basic flour and non-high-quality basic flour, and selecting a large gradient range ratio with a sedimentation value ≥46.0 mL and a dough development time ≥9.6 min;
(2) selecting the large gradient range ratio with a sedimentation value ≥46.0 mL and a dough development time ≥9.6 min for small gradient proportioning, and selecting a small gradient range ratio with a sedimentation value ≥46.0 mL and a dough development time ≥9.6 min; and
(3) conducting blending, then making bread and noodles for scoring, and determining a blending ratio when a score is greater than or equal to 80 points to terminate the blending.

In the present disclosure, 2-3 of large gradient range ratios are set for high-quality basic flour and non-high-quality basic flour, and a large gradient range ratio is selected with a sedimentation value ≥46.0 mL and a dough development time ≥9.6 min. The non-high-quality basic flour is preferably selected from a group consisting of inferior basic flour and common basic flour. A noodle quality, a bread quality, proteins and dough properties are determined for twelve wheat varieties: Jimai 19, Jimai 20, Jimai 954072, Lumai 1, Lumai 14, Lumai 19, Qingfeng 1, Tainong 18, Xinmai 18, Zhengmai 366, Zhoumai 18 and Zimai 12. According to the results of a total score and results of proteins and dough properties, flour with a total score of bread quality and noodle quality both above 85 points is considered high-quality basic flour; and flour with a noodle quality score below 75 and a bread quality score below 65 is called inferior basic flour. High-quality and dual-purpose wheat varieties for bread and noodles are preferably Zhengmai 366, Jimai 20, and Jimai 954072; meanwhile, flour of high-quality and dual-purpose wheat variety for bread and noodles is selected as high-quality basic flour, preferably, with a sedimentation value ≥46 mL and a dough development time ≥9.6 min; more preferably, with a sedimentation value ≥48.0 mL and a dough development time ≥10.5 min; even more preferably with a sedimentation value ≥53.6 mL and a dough development time ≥11.9 min. The inferior basic flour is preferably derived from a group consisting of Lumai 1, Lumai 14, Qingfeng 1 and Tainong 18. The common basic flour is preferably commercially available common flour.

In the present disclosure, a gradient range ratio is selected with a sedimentation value ≥46.0 mL and a dough development time ≥9.6 min for small gradient proportioning, and a small gradient range ratio is selected with a sedimentation value ≥46.0 mL and a dough development time ≥9.6 min. According to the results of determined noodle quality, bread quality, proteins and dough properties of twelve wheat varieties, in steps (1) and (2), preferably, the sedimentation value is ≥48.0 mL and the dough development time is ≥10.5 min; more preferably, the sedimentation value is ≥53.6 mL and the dough development time is ≥11.9 min.

In the present disclosure, blending is conducted, bread and noodles are made for scoring, and a blending ratio is determined when a score is greater than or equal to 80 points to terminate the blending. Preferably, in step (3), if the score is less than 80 points, step (2) is repeated until the score is greater than or equal to 80 points, followed by determining the blending ratio to terminate the blending. Evaluation and scoring of the bread quality or noodle quality are conducted by five trained panelists. The scoring method includes bread quality scoring and noodle quality scoring; the bread quality scoring is preferably: a total score of 100 points, including 30 points for volume, 5 points for appearance, 5 points for crust texture, 5 points for crust color, 5 points for core color, 10 points for smoothness, 20 points for texture structure, 10 points for softness and 5 points for taste. The noodle quality scoring is preferably: a total score of 100 points, including 10 points for color, 10 points for appearance, 20 points for palatability, 25 points for toughness, 25 points for viscosity, 5 points for smoothness and 5 points for taste.

In the present disclosure, when high-quality basic flour is derived from Zhengmai 366 and the non-high-quality basic flour is common basic flour, the Zhengmai 366 and the common basic flour have a blending ratio of preferably 7:3 to 8:2, more preferably 7:3; flour obtained according to the above ratio not only satisfies a sedimentation value ≥53.6 mL and a dough development time ≥11.9 min, but also satisfies that after the flour is made into noodles or bread, the noodles or bread has a quality score of more than 80 points.

In the present disclosure, unless otherwise specified, all raw material components are commercially available products well known to those skilled in the art.

Technical solutions in the present disclosure are clearly and completely described below in conjunction with examples herein. It is clear that described examples are merely a part, rather than all examples of the present disclosure. Based on examples of the present disclosure, all other examples obtained by person of ordinary skill in the art without creative efforts shall fall within protection scope of the present disclosure.

In following examples of the present disclosure, common flour is purchased from Fulinmen All-purpose Wheat Flour.

### Example 1: Correlation Analysis of Proteins and Dough Properties with Processing Qualities of Bread and Noodles

### 1. MATERIALS AND METHODS

1.1. Material Planting and Experimental Design

A total of twelve wheat varieties were selected as materials, including: Jimai 19, Jimai 20, Jimai 954072, Lumai 1, Lumai 14, Lumai 19, Qingfeng 1, Tainong 18, Xinmai 18, Zhengmai 366, Zhoumai 18 and Zimai 12, followed by planting in three ecological regions of Jinan, Heze and Pingdu in Shandong Province in 2014-2015 and 2015-2016, respectively. Randomized block design was conducted, wherein a plot area was 12 m², a length was 8 m, 6 rows with a row spacing of 25 cm, and 3 repetitions were set up. The routine field management was conducted.

1.2. Determination Standards and Methods

2 kg of grains were harvested from each block, and after being placed for 2 months, the grains were ground by a German Buhler experimental mill according to an AACC26-21A method. Wheat wetting was conducted for 24 h according to an AACC26-10 method, wherein a moisture of hard wheat was adjusted to 15%, and a moisture of soft wheat was adjusted to 14%. After a flour maturing of 2 weeks, the flour is used for determination of indicators.

A grain hardness was measured by an SKCS 4100 single kernel hardness tester (Perten Instruments, Sweden); protein contents of grains/flour was measured by a DA7200 near-infrared instrument (Perten Instruments, Sweden); gluten parameters were measured using a Gluten index 2200 gluten washing machine (Perten Instruments, Sweden); a Zeleny sedimentation value was determined according to an AACC56-61A method; flour farinograph parameters were measured using an automatic Farinograph of model 810152 (Brabender, Germany).

Production of noodles was referring to an SB/T10137-1993 method.

Production of bread was referring to a GB/T14611-1993 method.

1.3. Data Processing

Multivariate analysis of variance and correlation analysis were conducted on obtained data using SPSS 16.0.

### 2. RESULTS AND ANALYSIS

2.1. Analysis of Processing Quality of Bread and Noodles Derived from Different Wheat Varieties

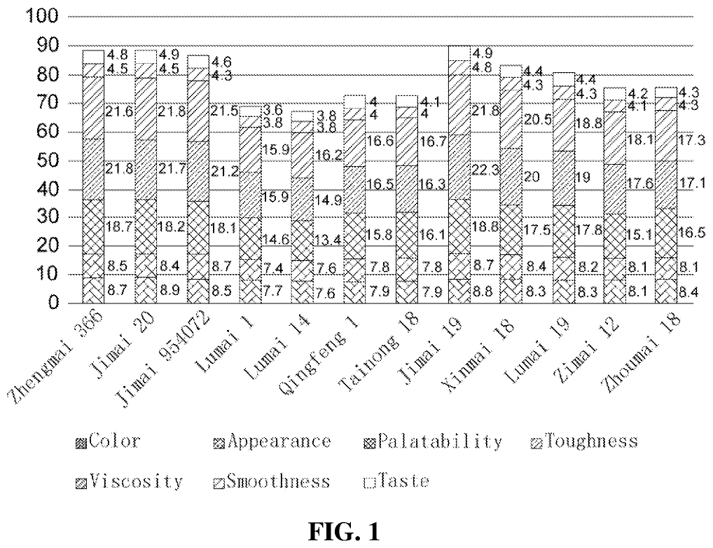

FIG. 1 shows an average performance of noodle quality of twelve wheat varieties in three ecological regions in two years. Zhengmai 366, Jimai 20, Jimai 954072 and Jimai 19 had a total score of above 85 points, which belonged to varieties for high-quality noodles. Lumai 1, Lumai 14, Qingfeng 1 and Tainong 18 had a score of below 75 points, indicating a poor noodle quality.

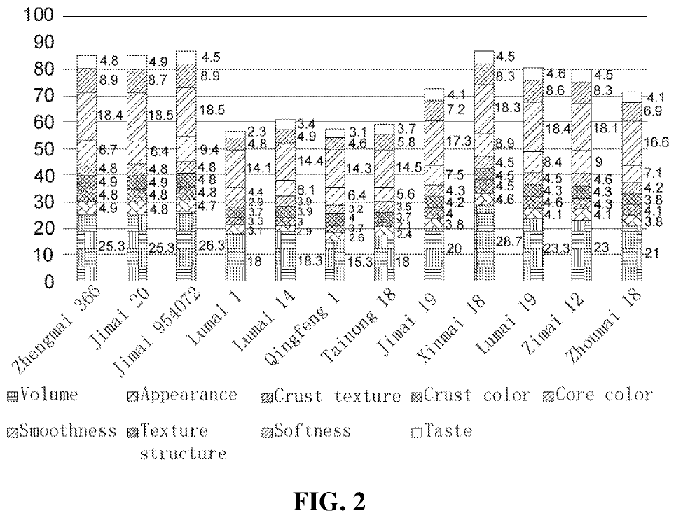

FIG. 2 shows an average performance of bread quality of the twelve varieties in three ecological regions in two years. Zhengmai 366, Jimai 20, Jimai 954072 and Xinmai 18 had a total score of above 85 points, which belonged to varieties for high-quality bread. Lumai 1, Lumai 14, Qingfeng 1 and Tainong 18 had a score below 65 points, indicating a poor bread quality.

2.1. Analysis of Proteins and Dough Properties of Different Wheat Varieties

It can be seen from Table 1 that quality indicators of twelve varieties in three ecological regions in two years were significantly different; from comparison of indicators for proteins and dough of 4 high-quality noodles and 4 poor-quality noodles. It can be seen that all indicators of wheat varieties for high-quality noodles were significantly better than those for poor-quality noodles; wherein grain protein content (GP) and flour protein content (FP), dry gluten content (DG), gluten indicator (GI), sedimentation value (SV), dough development time (DT), farinograph quality indicator (FQI), softening degree (SD) and other indicators had no overlap between varieties for high-quality noodles and for poor-quality noodles. That is to say, the lowest corresponding indicators among 4 varieties for high-quality noodles were also higher than that the highest among the 4 varieties for poor quality, indicating that these indicators might be critical to processing quality of noodles. Grain hardness (GH), wet gluten content (WG), dough stability time (ST), water absorption (WA) and other indicators had overlaps between varieties for high-quality noodles and for poor-quality noodles, indicating that the noodle quality requirements for these indicators might be relatively relaxed. Among corresponding indicators of 4 varieties for high-quality bread and 4 varieties for poor-quality bread, only GH, WG and WA rate had overlaps between the two varieties; while GP, FP, DG, GI, SV, DT, ST, FQI and SD had no overlap between the two varieties. ST with overlap in noodle quality had no overlap at all between the two varieties in bread quality, indicating that the bread quality might have stricter requirements on the stability time. In terms of bread quality and noodle quality, 3 of 4 varieties for high-quality noodle had high bread quality, while 4 varieties for poor quality noodles also had poor bread quality, indicating noodles and bread might have similar requirements for proteins and dough properties, but bread quality might be higher.

TABLE 1
Comparison of proteins and dough properties of twelve varieties of three regions in two years

| | GH | GP | FP | WG | DG | GI | SV | DT | ST | FQI | SD | WA |
|---|---|---|---|---|---|---|---|---|---|---|---|---|
| Variety | (%) | (%) | (%) | (%) | (%) | (%) | (mL) | (min) | (min) | (mm) | (FE) | (%) |
| Zhengmai 366 | 74.9a | 15.5a | 11.8b | 33.7bc | 13.1ab | 93.6a | 47.2b | 9.9a | 15.5b | 185.7ab | 44.3d | 65.7ab |
| Jimai 20 | 71.4b | 14.8ab | 11.3bc | 32.7c | 12.4b | 93.3a | 46.6b | 9.6a | 19.9a | 223.0a | 31.5d | 61.7c |
| Jimai 954072 | 66.4c | 15.4a | 12.5a | 35.0bc | 13.7a | 91.9a | 53.6a | 11.9a | 15.8b | 214.7a | 39.8d | 65.7ab |
| Lumai 1 | 36.0d | 14.3b | 10.8cd | 32.9c | 11.3c | 55.4d | 28.5e | 2.5c | 3.0d | 43.2d | 143.8a | 60.4c |
| Lumai 14 | 70.8b | 14.2b | 10.8cd | 34.2bc | 12.3bc | 72.7c | 37.0d | 4.3c | 6.0cd | 85.2c | 82.3bc | 65.7ab |
| Qingfeng 1 | 73.7ab | 13.4c | 10.0e | 30.8c | 11.2c | 78.2bc | 35.4d | 4.6bc | 9.1c | 107.6c | 64.2c | 64.0b |
| Tainong 18 | 74.8a | 13.6bc | 10.2de | 30.8c | 11.1c | 75.8bc | 35.4d | 4.7bc | 8.9c | 105.2c | 67.1c | 63.4bc |
| Jimai 19 | 73.5ab | 14.8ab | 11.2c | 35.6b | 12.8ab | 78.6bc | 46.0 b | 5.2bc | 8.8c | 115.0bc | 61.0cd | 66.1a |
| Xinmai 18 | 36.1d | 15.3a | 11.5bc | 32.2c | 12.3bc | 89.9a | 46.7b | 6.9b | 13.9b | 154.7b | 50.2cd | 59.9c |
| Lumai 19 | 69.3b | 15.2a | 12.4a | 38.3a | 13.5a | 70.5c | 41.9c | 4.6bc | 5.2d | 84.7c | 96.6b | 66.3a |
| Zimai 12 | 75.1a | 13.8bc | 10.7d | 32.1c | 11.7bc | 82.2b | 41.6c | 4.4c | 5.4d | 80.2cd | 88.0b | 66.4a |
| Zhoumai 18 | 65.2c | 14.9ab | 11.7b | 35.7b | 12.0bc | 70.1c | 37.3d | 3.9c | 5.0d | 73.7cd | 94.3b | 63.3bc |
| Mean | 65.6 | 14.6 | 11.2 | 33.7 | 12.3 | 79.4 | 41.4 | 6 | 9.7 | 122.7 | 71.9 | 64 |

Notes:
data followed by a same letter indicate no significant difference at 1% level.

2. 3. Correlation Analysis of Proteins and Dough Properties with Processing Qualities of Bread and Noodles

From Table 2, correlation analysis of total score of bread and noodles with protein and dough properties of twelve wheat varieties in three ecological regions in two years showed that: GP, GI, SV, and DT were significantly positively correlated with quality of bread and noodles, further indicating that bread and dough had similar requirements for main proteins and dough properties. FP, DG, ST and FQI all had an extremely significant positive correlation with one of bread and noodles, and reached a significant correlation with the other. There was no significant correlation between WG and WA for bread and noodles, and SD was only significantly correlated with noodles and had no significant correlation with bread. From perspective of correlation coefficient, correlation coefficients between SV and processing quality of bread and noodles were the highest value.

TABLE 2
Correlation analysis of proteins and dough properties with bread quality
and noodle quality of three regions in two years

| | GH | GP | FP | WG | DG | GI | SV | DT | ST | FQI | SD | WA | NS | BS |
|---|---|---|---|---|---|---|---|---|---|---|---|---|---|---|
| GH | 1 | | | | | | | | | | | | | |
| GP | −0.2 | 1 | | | | | | | | | | | | |
| FP | −0.1 | 0.9** | 1 | | | | | | | | | | | |
| WG | 0.1 | 0.6* | 0.8** | 1 | | | | | | | | | | |
| DG | 0.2 | 0.9** | 0.9** | 0.7** | 1 | | | | | | | | | |
| GI | 0.3 | 0.4 | 0.3 | −0.2 | 0.4 | 1 | | | | | | | | |
| SV | 0.2 | 0.7* | 0.6* | 0.3 | 0.8** | 0.9** | 1 | | | | | | | |
| DT | 0.2 | 0.6* | 0.5 | 0.0 | 0.6* | 0.9** | 0.9** | 1 | | | | | | |
| ST | 0.1 | 0.5 | 0.3 | −0.2 | 0.4 | 0.9** | 0.8** | 0.9** | 1 | | | | | |
| FQI | 0.2 | 0.5 | 0.4 | −0.1 | 0.5 | 0.9** | 0.8** | 1.0** | 1.0** | 1 | | | | |
| SD | −0.4 | −0.3 | −0.2 | 0.2 | −0.4 | −0.9** | −0.8** | −0.8** | −0.9** | −0.9** | 1 | | | |
| WA | 0.8** | 0.0 | 0.2 | 0.5 | 0.5 | 0.1 | 0.3 | 0.1 | −0.2 | −0.0 | −0.1 | 1 | | |
| NS | 0.2 | 0.7** | 0.6* | 0.3 | 0.7* | 0.7** | 0.9** | 0.8** | 0.7** | 0.8** | −0.7* | 0.1 | 1 | |
| BS | 0.0 | 0.8** | 0.7** | 0.3 | 0.7** | 0.7** | 0.9** | 0.7** | 0.6* | 0.7* | −0.6 | 0.1 | 0.8** | 1 |

Note:
* and ** indicate 5% and 1% significant differences, respectively; wherein NS: noodle scoring; and BS: bread scoring, other abbrs. are the same as Table 1

### 3. CONCLUSIONS

Quality of bread and noodles had similar requirements for main proteins and dough properties; four key indicators, GP, GI, SV, and DT, were significantly positively correlated with quality of bread and noodles, that was, GP, GI, SV and DT were key indicators of proteins and dough properties that affected quality of bread and noodles. SV had the highest correlation coefficient between bread and noodle scoring.

After experiments, it was determined that high-quality and dual-purpose wheat for bread and noodles were Zhengmai 366, Jimai 20 and Jimai 954072. Specific values of four key indicators of proteins and noodle properties of three wheat varieties above were shown in Table 3.

TABLE 3
Four key indicators of key proteins and dough features of three
high-quality wheat varieties of three regions in two years

| Variety | GP(%) | GI(%) | SV(mL) | DT(min) |
|---|---|---|---|---|
| Zhengmai 366 | 15.5 | 93.6 | 47.2 | 9.9 |
| Jimai 20 | 14.8 | 93.3 | 46.6 | 9.6 |
| Jimai 954072 | 15.4 | 91.9 | 53.6 | 11.9 |
| Mean | 15.2 | 92.9 | 49.1 | 10.5 |

Since there were only 3 high-quality and dual-purpose wheat varieties for bread and noodles provided in this experiment, to prevent errors caused by too small sample size, wheat varieties with higher values among twelve varieties were screened to calculate an mean value; wherein GP, GI and DT, values with no significant difference at 1% significant level and at the level “a” were selected to calculate mean value; for SV, since only one variety, Jimai 954072, had value of level “a”, the selected value included level “b”, and Table 4 was obtained.

TABLE 4
Four key indicators of proteins and dough properties of
wheat varieties with higher values among twelve varieties

| Variety | GP(%) | GI(%) | SV(mL) | DT(min) |
|---|---|---|---|---|
| Zhengmai 366 | 15.5a | 93.6a | 47.2b | 9.9a |
| Jimai 20 | 14.8ab | 93.3a | 46.6b | 9.6a |
| Jimai 954072 | 15.4a | 91.9a | 53.6a | 11.9a |
| Lumai 1 | | | | |
| Lumai 14 | | | | |
| Qingfeng 1 | | | | |
| Tainong 18 | | | | |
| Jimai 19 | 14.8ab | | 46.0 b | |
| Xinmai 18 | 15.3a | 89.9a | 46.7b | |
| Lumai 19 | 15.2a | | | |
| Zimai 12 | | | | |
| Zhoumai 18 | 14.9ab | | | |
| Mean | 15.2 | 92.2 | 48.0 | 10.5 |

Notes:
data followed by a same letter indicate no significant difference at the 1% level.

Comparing mean values of key proteins and dough properties in Table 3 and Table 4, it was found that key proteins and dough properties in Table 3 were the same or slightly higher than those in Table 4, which was in line with theoretical logic. The data were statistically significant.

Therefore, high-quality and dual-purpose flour for bread and noodles had a SV ≥46 mL and a DT ≥9.6 min; preferably a SV ≥48.0 mL and a DT ≥10.5 min; more preferably, a SV≥53.6 mL, and a DT ≥11.9 min.

### Example 2: Effects of Flour Blending on Processing Quality, Proteins and Dough Properties of Wheat-Based Bread and Noodles

High-quality and dual-purpose wheat varieties Jimai 954072 and Zhengmai 366 and inferior varieties Qingfeng 1 and Lumai 1 for bread and noodles were selected, respectively to conduct flour blending, and effects of the flour blending were studied on physicochemical properties of protein and starch and quality of food processing.

1. Effects of Flour Blending on Processing Quality of Bread and Noodles

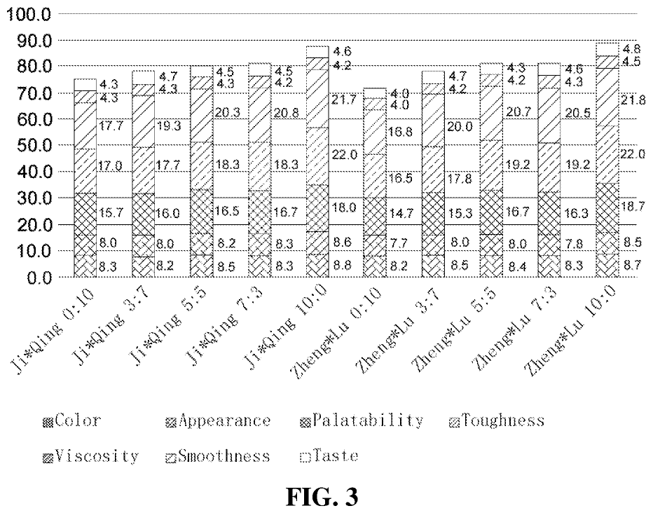

Results illustrated in FIG. 3 show that flour blending had a significant effect on quality of bread and noodles; judging from noodle scores. After Qingfeng 1 and Lumai 1 were added with 50% of Jimai 954072 and Zhengmai 366, respectively, total noodles scores could reach more than 80 points; after a small amount (30%) of high-quality flour was added, bread qualities of Qingfeng 1 and Lumai 1 improved rapidly by 28.6% and 30.2%, respectively. However, continuing to add high-quality flour improved bread scores slowly.

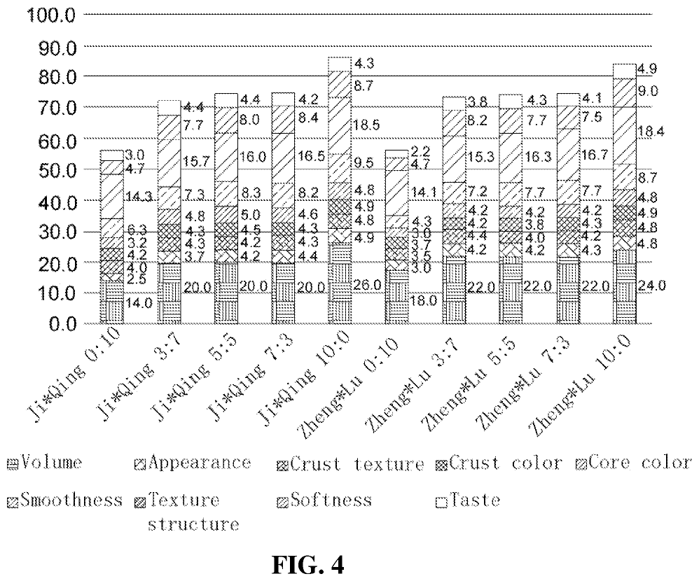

Results illustrated in FIG. 4 show that from bread scores of two groups of flour blending, even if Qingfeng 1 and Lumai 1 were added with 70% of Jimai 954072 and Zhengmai 366, respectively, total bread scores did not reach more than 80 points. However, when it was added by 50%, the total bread score was already close to 80 points. This might be due to the fact that two wheat varieties, which were both inferior types with very low total bread scores, which could not be converted into a high-quality flour for making bread even if 50% of high-quality flour was added. However, after a small amount (30%) of high-quality flour was added, bread qualities of Qingfeng 1 and Lumai 1 improved rapidly by 28.6% and 30.2%, respectively; however, continuing to add high-quality flour improved bread scores slowly.

II. Effects of Flour Blending on Proteins and Dough Properties

In Table 5, from perspective of proteins and dough properties, all indicators after flour blending showed regular changes with flour blending ratio.

TABLE 5
Comparison of mean value of proteins and dough properties after flour blending (FB)

| | WG | DG | GI | FP | SV | DT | ST | FQI | SD | WA |
|---|---|---|---|---|---|---|---|---|---|---|
| FB ratio | (%) | (%) | (%) | (%) | (mL) | (min) | (min) | (mm) | (FE) | (%) |
| Ji: Qing = 0:10 | 30.5 | 10.8 | 84.1 | 10.3 | 34.5 | 3.6 | 5.2 | 70 | 86 | 65.0 |
| Ji: Qing = 3:7 | 32.2 | 11.7 | 84.4 | 11.1 | 39.7 | 4.8 | 8.8 | 113 | 56 | 65.1 |
| Ji: Qing = 5:5 | 33.1 | 12.5 | 84.1 | 11.7 | 42.3 | 7.4 | 8.8 | 117 | 65 | 65.5 |
| Ji: Qing = 7:3 | 35.0 | 13.5 | 85.6 | 12.3 | 45.7 | 7.7 | 9.3 | 132 | 55 | 66.0 |
| Ji: Qing = 10:0 | 36.0 | 14.1 | 89.4 | 13.4 | 46.6 | 9.6 | 12.2 | 182 | 45 | 66.3 |

3. Correlations Between Bread Quality and Noodle Quality after Flour Blending with Quality Traits of Wheat

It can be seen from Table 6 that proteins, SV, DT, ST, and FQI of flour were significantly or extremely significantly positively correlated with scores of bread and noodles, and SD had an extremely significant and significant negative correlation with total score of bread and noodles, respectively. This was basically consistent with the conclusion of key indicators that affect bread quality and noodle quality summarized earlier.

TABLE 6
Correlation of total score with proteins and dough properties for two groups of bread
and two groups of noodles after flour blending

| Trait | FP | WG | DG | GI | SV | DT | ST | FQI | SD | WA | NS | BS |
|---|---|---|---|---|---|---|---|---|---|---|---|---|
| FP | 1 | 0.97** | 0.97** | 0.80** | 0.99** | 0.97** | 0.93** | 0.96** | −0.85** | 0.78** | 0.87** | 0.92** |
| WG | 0.97** | 1 | 0.97** | 0.74** | 0.96** | 0.94** | 0.90** | 0.94** | −0.86** | 0.84** | 0.82** | 0.89** |
| DG | 0.97** | 0.97** | 1 | 0.67** | 0.95** | 0.93** | 0.86** | 0.92** | −0.83** | 0.79** | 0.80** | 0.86** |
| GI | 0.80** | 0.74** | 0.67** | 1 | 0.83** | 0.74** | 0.76** | 0.81** | −0.65** | 0.72** | 0.79** | 0.65** |
| SV | 0.99** | 0.96** | 0.95** | 0.83** | 1 | 0.95** | 0.94** | 0.98** | −0.85** | 0.78** | 0.88** | 0.91** |
| DT | 0.97** | 0.94** | 0.93** | 0.74** | 0.95** | 1 | 0.90** | 0.92** | −0.76** | 074** | 0.82** | 0.90** |
| ST | 0.93** | 0.90** | 0.86** | 0.76** | 0.94** | 0.90** | 1 | 0.95** | −0.92** | 0.64* | 0.82** | 0.97** |
| FQI | 0.96** | 0.94** | 0.94** | 0.92** | 0.98** | 0.92** | 0.95** | 1 | −0.91** | 0.78** | 0.84** | 0.93** |
| SD | −0.85** | −0.86** | −0.83** | −0.83** | −0.85** | −0.76** | −0.92** | −0.91** | 1 | −0.71** | −0.73** | −0.90** |
| WA | 0.78** | 0.84** | 0.79** | 0.79** | 0.78** | 0.74** | 0.64* | 0.78** | −71** | 1 | 0.65** | 0.64** |
| NS | 0.87** | 0.82** | 0.80** | 0.79** | 0.88** | 0.82** | 0.82** | 0.84** | −0.73** | 0.65** | 1 | 0.77** |
| BS | 0.92** | 0.89** | 0.86** | 0.65** | 0.91* | 0.90** | 097** | 0.93** | −0.90** | 0.64** | 0.77** | 1 |

Note:
* and ** indicate 5% and 1% significant differences, respectively.

In summary, from the perspective of effects of flour blending, effects of flour blending on noodle quality were better than that on bread quality, and noodle quality after flour blending was basically proportionally improved.

### Example 3

A blending method of high-quality and dual-purpose flour for bread and noodles includes the following steps:
(1) 2-3 of large gradient range ratios were set up for high-quality basic flour and non-high-quality basic flour, and a large gradient range ratio was selected with a SV ≥46.0 mL and a DT ≥9.6 min; wherein the non-high-quality basic flour was inferior basic flour or common basic flour, and the high-quality basic flour was flour derived from a high-quality and dual-purpose wheat variety for bread and noodles; a flour derived from the high-quality and dual-purpose wheat variety for bread and noodles had a flour SV ≥46.0 mL and a DT ≥9.6 min, such as flour prepared by Zhengmai 366, Jimai 20 or Jimai 954072; the inferior basic flour was made by Lumai 1, Lumai 14, Qingfeng 1 or Tainong 18;
(2) the large gradient range ratio with a SV ≥46.0 mL and a DT ≥9.6 min was selected for small gradient proportioning, and a small gradient range ratio was selected with a SV ≥46.0 mL and a DT ≥9.6 min; and
(3) the high-quality basic flour and the non-high-quality basic flour were blended according to the small gradient range ratio obtained in step (2), bread and noodles were made for scoring, and a blending ratio was determined when a score was greater than or equal to 80 points to terminate the blending; if the score was less than 80 points, step (2) was repeated until the score was greater than or equal to 80 points, followed by determining blending ratio to terminate the blending.

Evaluation and scoring of bread quality or noodle quality were conducted by five trained panelists. The scoring method included bread quality scoring and noodle quality scoring. Bread quality scoring was preferably: a total score of 100 points, including 30 points for volume, 5 points for appearance, 5 points for crust texture, 5 points for crust color, 5 points for core color, 10 points for smoothness, 20 points for texture structure, 10 points for softness and 5 points for taste. Noodle quality scoring was preferably: a total score of 100 points, including 10 points for color, 10 points for appearance, 20 points for palatability, 25 points for toughness, 25 points for viscosity, 5 points for smoothness and 5 points for taste.

### Example 4

A blending method of high-quality and dual-purpose flour for bread and noodles included the following steps:
(1) 2-3 of large gradient range ratios were set up for high-quality basic flour and non-high-quality basic flour, and a large gradient range ratio was selected with a SV ≥48.0 mL and a DT ≥10.5 min; wherein the non-high-quality basic flour was inferior basic flour or common basic flour, and the high-quality basic flour was flour derived from a high-quality and dual-purpose wheat variety for bread and noodles; a flour derived from the high-quality and dual-purpose wheat variety for bread and noodles had a flour SV ≥48.0 mL and a DT ≥10.5 min, such as the flour prepared by Jimai 954072; the inferior basic flour was made by Lumai 1, Lumai 14, Qingfeng 1 or Tainong 18;
(2) the large gradient range with a SV ≥48.0 mL and a DT ≥10.5 min was selected for small gradient proportioning, and a small gradient range ratio was selected with a SV ≥48.0 mL and a DT ≥10.5 min; and
(3) the high-quality basic flour and the non-high-quality basic flour were blended according to the small gradient range ratio obtained in step (2), bread and noodles were made for scoring, and a blending ratio was determined when a score was greater than or equal to 80 points to terminate the blending; if the score was less than 80 points, step (2) was repeated until the score was greater than or equal to 80 points, followed by determining the blending ratio to terminate the blending.

Evaluation and scoring of bread quality or noodle quality were conducted by five trained panelists. The scoring method included bread quality scoring and noodle quality scoring; the bread quality scoring was preferably: a total score of 100 points, including 30 points for volume, 5 points for appearance, 5 points for crust texture, 5 points for crust color, 5 points for core color, 10 points for smoothness, 20 points for texture structure, 10 points for softness and 5 points for taste. The noodle quality scoring was preferably: a total score of 100 points, including 10 points for color, 10 points for appearance, 20 points for palatability, 25 points for toughness, 25 points for viscosity, 5 points for smoothness and 5 points for taste.

### Example 5

A blending method of high-quality and dual-purpose flour for bread and noodles included the following steps:
(1) 2-3 of large gradient range ratios were set up for high-quality basic flour and non-high-quality basic flour, and a large gradient range ratio was selected with a SV ≥53.6 mL and a DT ≥11.9 min; wherein the non-high-quality basic flour was inferior basic flour or common basic flour, and the high-quality basic flour was flour derived from a high-quality and dual-purpose wheat variety for bread and noodles; a flour derived from the high-quality and dual-purpose wheat variety for bread and noodles had a flour SV ≥53.6 mL and a DT ≥11.9 min, such as the flour prepared by Jimai 954072; the inferior basic flour was made by Lumai 1, Lumai 14, Qingfeng 1 or Tainong 18;
(2) the large gradient range ratio with a SV ≥53.6 mL and a DT ≥11.9 min was selected for small gradient proportioning, and a small gradient range ratio was selected with a SV ≥53.6 mL and a DT ≥11.9 min; and
(3) the high-quality basic flour and the non-high-quality basic flour were blended according to the small gradient range ratio obtained in step (2), bread and noodles were made for scoring, and a blending ratio was determined when a score was greater than or equal to 80 points to terminate the blending; if the score was less than 80 points, step (2) was repeated until the score was greater than or equal to 80 points, followed by determining the blending ratio to terminate the blending.

Evaluation and scoring of bread quality or noodle quality were conducted by five trained panelists. The scoring method included bread quality scoring and noodle quality scoring. The bread quality scoring was preferably: a total score of 100 points, including 30 points for volume, 5 points for appearance, 5 points for crust texture, 5 points for crust color, 5 points for core color, 10 points for smoothness, 20 points for texture structure, 10 points for softness and 5 points for taste. The noodle quality scoring was preferably: a total score of 100 points, including 10 points for color, 10 points for appearance, 20 points for palatability, 25 points for toughness, 25 points for viscosity, 5 points for smoothness and 5 points for taste.

### Example 6 Blending of High-Quality and Dual-Purpose Flour for Bread and Noodles Using Key Indicators of Proteins and Dough Properties

Zhengmai 366 was selected as high-quality and dual-purpose flour for bread and noodles to conduct flour blending. The Zhengmai 366 had a GP (15.4%), a GI (91.9%), a SV (53.6 mL) and a DT (11.9 min), which met requirements of high-quality and dual-purpose flour for bread and noodles.

A common flour, Fulinmen All-purpose Wheat Flour, was purchased from market without determination of proteins and dough properties.

A large gradient experiment was conducted to preliminarily determine a blending range. The Zhengmai 366 (code-named Z) and common flour (code-named W) had a ratio as follows: Z:W=3:7, Z:W=5:5, Z:W=8:2; a small amount of Z flour and W flour were weighed, respectively, and 500 g of blended flour was prepared according to the blending ratio, followed by measuring the SV and DT (Table 7).

TABLE 7
Measurement results of SV and DT of large gradient

| Z:W ratio | 3:7 | 5:5 | 8:2 |
|---|---|---|---|
| SV (mL) | 30.8 | 43.2 | 48.3 |
| DT (min) | 3.9 | 9.0 | 9.8 |

It can be seen from the SV that at the ratio of 8:2, the sedimentation value reached the standard of high-quality and dual-purpose flour for bread and noodles.

To save high-quality flour, a small gradient experiment was optionally conducted between ratio of 5:5 and 8:2 to find a ratio reaching a critical point of the high-quality and dual-purpose flour for bread and noodles.

A large gradient experiment was conducted to preliminarily determine a blending range. The ratio of Zhengmai 366 (code-named Z) to common flour (code-named W) were adjusted as follows: Z:W=6:4, Z:W=7:3, Z:W=8:2; a small amount of Z flour and W flour were weighed, respectively, and 500 g of blended flour was prepared according to the blending ratio, followed by measuring SV and DT (Table 8).

TABLE 8
Measurement results of SV and DT of small gradient

| Z:W ratio | 6:4 | 7:3 | 8:2 |
|---|---|---|---|
| SV (mL) | 44.8 | 46.2 | 48.3 |
| DT (min) | 9.3 | 9.6 | 9.8 |

From the results of the small gradient experiment, when the ratio of Z:W was 7:3, SV reached 46.2 ml, which was slightly higher than 46.0 ml, besides, DT reached 9.6 min.

According to the ratio of Z:W of 7:3, 5,000 g of blended flour was prepared, and the Zhengmai 366, common flour and blended flour were used to make bread for bread quality scoring, respectively (Table 9).

TABLE 9
Bread quality scores of Zhengmai 366,
common flour and blended flour

| | Zhengmai 366- | Common flour- | Blended flour- |
|---|---|---|---|
| Bread quality | based bread | based bread | based bread |
| Volume | 25.3 | 18.1 | 25.0 |
| Appearance | 4.9 | 3.3 | 4.6 |
| Crust texture | 4.8 | 3.3 | 4.4 |
| Crust color | 4.9 | 3.8 | 4.6 |
| Core color | 4.8 | 3.0 | 4.3 |
| Smoothness | 8.7 | 4.4 | 8.5 |
| Texture structure | 18.4 | 14.2 | 18.1 |
| Softness | 8.9 | 4.9 | 8.6 |
| Taste | 4.8 | 2.5 | 4.5 |
| Total score | 85.5 | 57.5 | 82.6 |

From the scoring results of bread quality in Table 9, scores of blended flour-based bread were much higher than that of common flour-based bread.

The Zhengmai 366, common flour and blended flour were used to make noodles for noodle quality scoring (Table 10).

TABLE 10
Noodle quality scores of Zhengmai
366, common flour and blended flour

| | Zhengmai 366- | Common flour- | Blended flour- |
|---|---|---|---|
| Noodle quality | based noodle | based noodle | based noodle |
| Color | 8.7 | 7.8 | 8.3 |
| Appearence | 8.5 | 7.5 | 8.2 |
| Palatability | 18.7 | 14.6 | 18.1 |
| Toughness | 21.8 | 15.9 | 21.0 |
| Viscosity | 21.6 | 16.0 | 21.0 |
| Smoothness | 4.5 | 3.8 | 4.2 |
| Taste | 4.8 | 3.9 | 4.5 |
| Total score | 88.6 | 69.5 | 85.3 |

From the scoring results of noodle quality in Table 10, scores of blended flour-based noodles were much higher than that of common flour-based noodles.

The above descriptions are merely preferred embodiments of the present disclosure. It should be noted that a person of ordinary skill in the art may further make several embodiments and modifications without departing from the principle of the present disclosure, which also should be deemed as falling within the claimed scope of the present disclosure.

What is claimed is:

1. A blending method of high-quality and dual-purpose flour for bread and noodles, comprising following steps:
(1) setting 2-3 of large gradient range ratios for high-quality basic flour and non-high-quality basic flour, and selecting a large gradient range ratio with a sedimentation value ≥46.0 mL and a dough development time ≥9.6 min;
(2) selecting the large gradient range ratio with a sedimentation value ≥46.0 mL and a dough development time ≥9.6 min for small gradient proportioning, and selecting a small gradient range ratio with a sedimentation value ≥46.0 mL and a dough development time ≥9.6 min; and
(3) blending the high-quality basic flour and the non-high-quality basic flour according to the small gradient range ratio obtained in step (2), making bread and noodles for scoring, and determining a blending ratio when a score is greater than or equal to 80 points to terminate the blending.

2. The blending method according to claim 1, wherein in step (3), if the score is less than 80 points, step (2) is repeated until the score is greater than or equal to 80 points, followed by determining the blending ratio to terminate the blending.

3. The blending method according to claim 1, wherein the non-high-quality basic flour is selected from a group consisting of inferior basic flour and common basic flour; and the inferior basic flour is derived from a group consisting of Lumai 1, Lumai 14, Qingfeng 1 and Tainong 18.

4. The blending method according to claim 1, wherein the high-quality basic flour is flour of a high-quality and dual-purpose wheat for bread and noodles, and the flour of the high-quality and dual-purpose wheat for bread and noodles has a sedimentation value ≥46.0 mL and a dough development time ≥9.6 min.

5. The blending method according to claim 4, wherein the high-quality and dual-purpose wheat for bread and noodles is selected from a group consisting of Zhengmai 366, Jimai 20 and Jimai 954072.

6. The blending method according to claim 1, wherein in steps (1) and (2), the sedimentation value is ≥48.0 mL, and the dough development time is ≥10.5 min.

7. The blending method according to claim 1, wherein in steps (1) and (2), the sedimentation value is ≥53.6 mL, and the dough development time is ≥11.9 min.

8. The blending method according to claim 1, wherein when the high-quality basic flour is derived from Zhengmai 366 and the non-high-quality basic flour is common basic flour, the Zhengmai 366 and the common basic flour have a blending ratio of 7:3 to 8:2.

9. The blending method according to claim 8, wherein the Zhengmai 366 and the common basic flour have a blending ratio of 7:3.
